(19) United States
(12) Patent Application Publication
(10) Pub. No.: US 2020/0031182 A1
(43) Pub. Date: Jan. 30, 2020

(54) SMART WHEEL CAP FOR VEHICLE

(71) Applicant: Do hyun LEE, Daejeon (KR)

(72) Inventor: Do hyun LEE, Daejeon (KR)

(21) Appl. No.: 16/130,653

(22) Filed: Sep. 13, 2018

(30) Foreign Application Priority Data
Jul. 26, 2018 (KR) 10-2018-0066539

(51) Int. Cl. B60C 23/04; B60B 7/00

(52) U.S. Cl. CPC B60C 23/0493; B60Q 1/326; B60B 7/006; B60C 23/0447

(57) ABSTRACT

Provided is a smart wheel cap for a vehicle, including: a front cover emitting light to the outside and including a cover body and an LED light emitting window mounted on a front border of the cover body; a cap including a cap-shaped cap body which is mounted on a back side of the front cover, and has the back side opened, and is transparent or translucent and a primary bearing mounted on a front inside of the cap body; a generator unit including a stator unit mounted on the back side of the cap and not rotating together with the front cover or cap and a rotor unit rotating together with the front cover or cap; and a rear cover coupled with the front cover and fixing locations of the cap and the generator unit, and having a mounting hook mounted on a wheel, provided on a back.

### BACKGROUND OF THE INVENTION

### 1. Field of the Invention

The present invention relates to a smart wheel cap for a vehicle, and more particularly, to a smart wheel cap for a vehicle, which is mounted on a wheel of a vehicle and measures a traveling distance of a tire in real time and transmits a tire replacement position and a wheel alignment value to a user terminal to easily acquire information on the tire.

### 2. Description of the Related Art

Modern times are the age of automobiles. Various types of engines are being produced, including gasoline engines, diesel engines and recently developed electric vehicles. As automobiles are made more and more, various technologies are being developed for users' individuality and stability while adding various devices to the automobiles. As a part of the technology development, technologies for automobile wheel caps that flicker at night in place of a manufacturer's logo cap of the automobile are being developed at the center of an automobile wheel.

The automobile wheel cap that flickers at night uses induced electromotive force generated by a coil and a magnet, and a generation principle of the induced electromotive force is commercialized as a general technology. In addition, a light emitting diode (LED) is generally used as a light emitting body, and since the LED does not require much power consumption and has a quick response time and a semi-permanent life, the LED is suitable for a light emitting body for automobile decoration, which needs to be used for a long time once the LED is mounted.

In the automobile wheel cap in the related art, the light emitting body such as the LED or the like merely flickers and it may not be judged whether the tire is worn or an object is present on a wheel alignment or a side surface of the vehicle and only a decorative meaning is just granted to the automobile wheel cap.

### SUMMARY OF THE INVENTION

In order to solve the problem, the present invention has been made in an effort to provide a smart wheel cap for a vehicle, which can measure states of a tire or a wheel, which include a traveling distance of a vehicle and an angle of the wheel.

The present invention has also been made in an effort to provide a smart wheel cap for a vehicle, which senses, when an object is present on a side surface of a vehicle, the presence of the object and inform a user of the presence of the object.

An exemplary embodiment of the present invention provides a smart wheel cap for a vehicle, including: a front cover emitting light to the outside and including a cover body and an LED light emitting window mounted on a front border of the cover body; a cap including a cap-shaped cap body which is mounted on a back side of the front cover, and has the back side opened, and is transparent or translucent and a primary bearing mounted on a front inside of the cap body; a generator unit including a stator unit including a pair of stationary discs mounted on the back side of the cap, formed on one side and the other side, a connecting p late connecting the pair of stationary discs to each other, a pair of bearing hooks formed on both stationary discs, respectively and mounted on a bearing, a magnet radially mounted on the other-side stationary disc, and a battery mounted on a lower portion of the connecting plate with one or more and serving as a balance weight and storing electricity generated by the magnet and a coil, and a rotor unit including a bearing on which the bearing hook of the other-side stationary disc with the magnet is mounted, a coil mounted on an edge and generating the electricity together with the magnet, and a rotary disc on which the bearing and the coil are mounted and rotating together with the front cover or cap; and a rear cover coupled with the front cover and fixing locations of the cap and the generator unit, and having a mounting hook mounted on a wheel, which is provided on a back.

In the generator unit, an LED module may be mounted on the one-side stationary disc and one or more printed circuit boards may be mounted on an upper portion of the connecting plate.

The cap may further include an auxiliary magnet radially mounted inside the side surface of the cap body, and the generator unit may include an auxiliary coil mounted on the one-side stationary disc in order to generate the electricity together with the auxiliary magnet, and a second battery unit including a secondary printed circuit board and an auxiliary battery in which the secondary printed circuit board is attached to one side, one side to which the secondary printed circuit board is attached is mounted on the back side of the rotary disc, and the other side fixed to the inside of the rear cover.

The printed circuit board may include a color control unit controlling a color of an LED, a side sensor for sensing an object on the side of a wheel, and a transmitting and receiving unit transmitting a signal sensed by the side sensor to an MCU and receiving a control signal of the MCU.

The secondary printed circuit board may include a gyro sensor for measuring the acceleration, the traveling distance, and the angle of the wheel of the vehicle, an MCU receiving signals sensed by the side sensor and the gyro sensor and receiving the control signal of the user terminal through a main transmitting and receiving unit to control the color control unit and the sensors, and a main transmitting and receiving unit transmitting the control signal to the user terminal or receiving the control signal of the user terminal and transmitting the received control signal to the MCU.

The printed circuit board may include a color control unit controlling the color of the LED, the side sensor for sensing the object on the side of the wheel, a gyro sensor for measuring an acceleration, a traveling distance, and an angle of the wheel of the vehicle, an MCU receiving signals sensed by the side sensor and the gyro sensor and receiving a control signal of a user terminal through a main transmitting and receiving unit and controlling the color control unit and the sensors, and a main transmitting and receiving unit transmitting the control signal of the MCU or receiving the control signal of the user terminal and transmitting the control signal to the MCU.

The user terminal may include a control unit that may display a total traveling distance, the acceleration of the vehicle, the angle of the wheel, and the color the LED, inform whether a tire is replaced when a set value for replacing the tire is reached from the total traveling distance, and control the color of the LED.

According to an exemplary embodiment of the present invention, when a replace time of tire front and rear positions of a tire set according to a traveling distance of a vehicle is reached, it is possible to inform a user of the replacement time, so that it is advantageous in that a use time of the tire can be increased.

Further, according to an exemplary embodiment of the present invention, when air pressures of the tires are the same as each other, wheels are not aligned with each other, resulting in wear of the unbalanced tire, but since the wear of the tire is informed to a user in advance, it is advantageous in that unbalanced wear of the tire can be reduced.

In addition, according to an exemplary embodiment of the present invention, since a color of an LED can be changed as necessary, a decorative effect can be exhibited and when the LED is emitted in red when a vehicle is operated at night, it is advantageous in that it can be notified that the vehicle is operated in advance when an object approaches a side surface.

Further, according to an exemplary embodiment of the present invention, it is notified that the object is present on the side surface to a user terminal, thereby preventing a safety accident.

### BRIEF DESCRIPTION OF THE DRAWINGS

FIG. 1 is a perspective view of a smart wheel cap for a vehicle according to the present invention.

FIG. 2 is an exploded perspective view of a smart wheel cap for a vehicle according to a first exemplary embodiment of the present invention.

FIG. 3 is an exploded perspective view of a smart wheel cap for a vehicle according to a second exemplary embodiment of the present invention.

FIG. 4 is an exploded perspective view of the smart wheel cap according to the first embodiment of the present invention, which is viewed from another aspect.

FIG. 5 is an exploded perspective view of the smart wheel cap according to the second embodiment of the present invention, which is viewed from another aspect.

FIG. 6A and FIG. 6B are perspective view and cross-sectional view of a generator unit of the smart wheel cap for a vehicle according to the first exemplary embodiment of the present invention.

FIG. 7A and FIG. 7B are perspective view and cross-sectional view of a generator unit of the smart wheel cap for a vehicle according to the second exemplary embodiment of the present invention.

FIG. 8 is a perspective view of a wing LED of a smart wheel cap for a vehicle according to the present invention.

FIG. 9 is a plan view illustrating that a toe value is measured by a smart wheel cap for a vehicle according to the present invention.

FIG. 10 is a front view illustrating that a camber value is measured by the smart wheel cap for a vehicle according to the present invention.

FIG. 11 is a side view illustrating that a caster value is measured by the smart wheel cap for a vehicle according to the present invention.

FIG. 12 is a block diagram illustrating communication among a smart wheel cap, and a user terminal and a server according to the present invention.

### DETAILED DESCRIPTION OF THE PREFERRED EMBODIMENTS

Hereinafter, exemplary embodiments of the present invention in which the above objects can be specifically realized will be described in detail with reference to the accompanying drawings. In describing the exemplary embodiment, the same name and the same reference numeral are used with respect to the same component and the resulting additional description will be omitted.

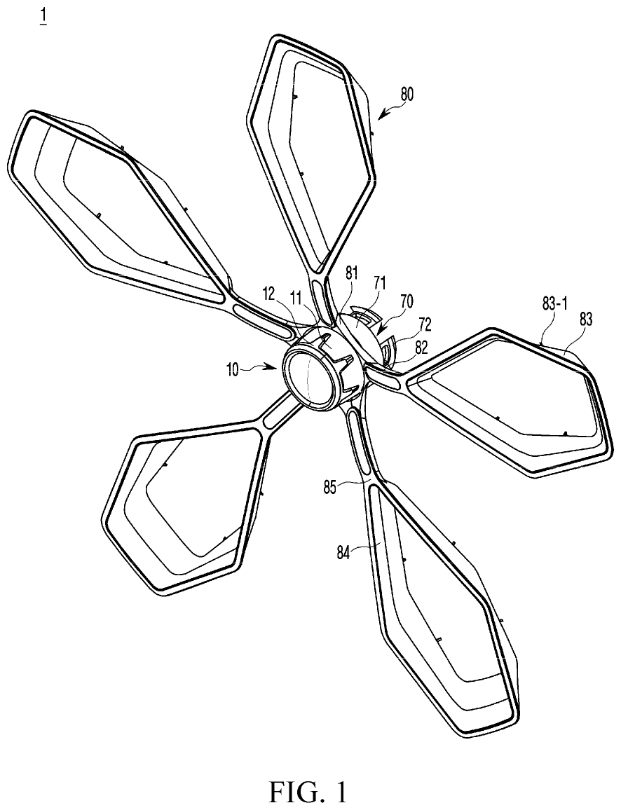

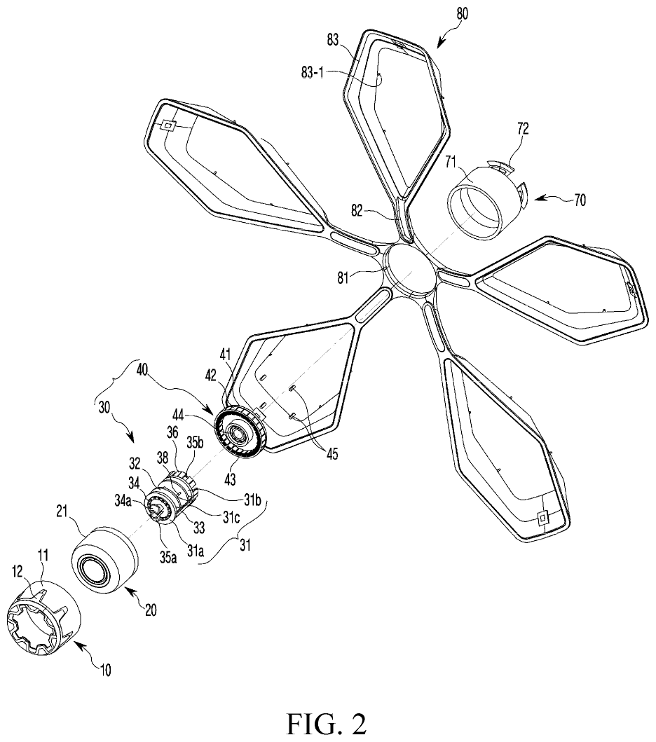

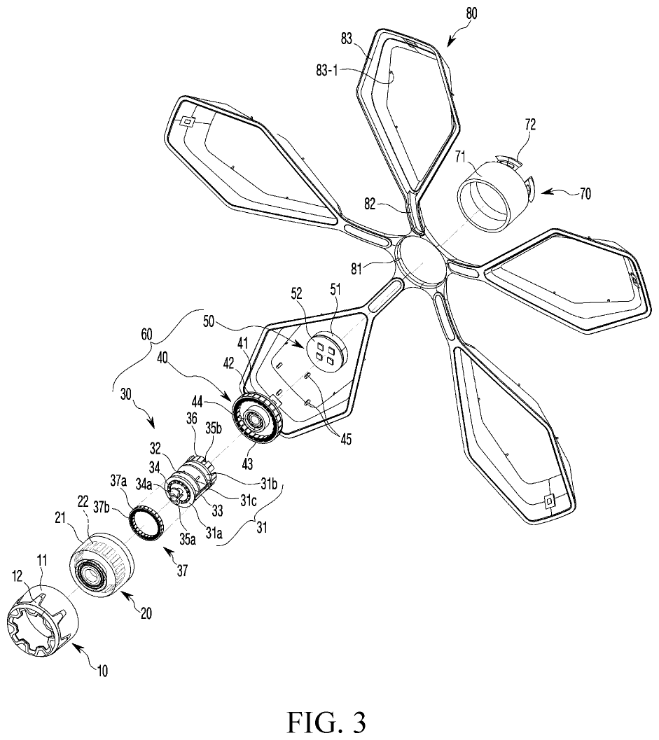

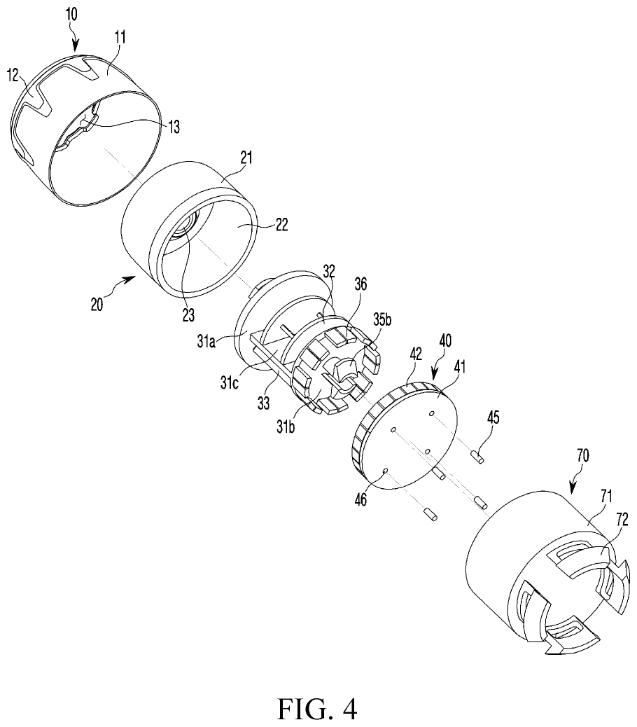

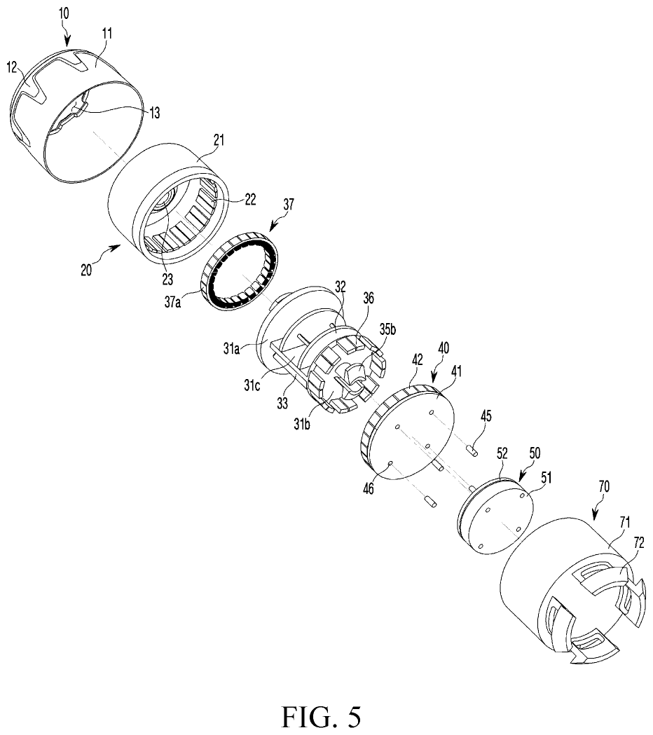

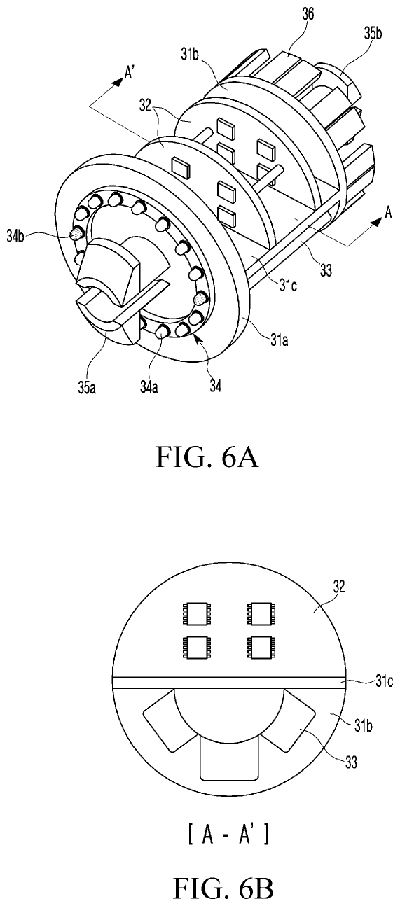

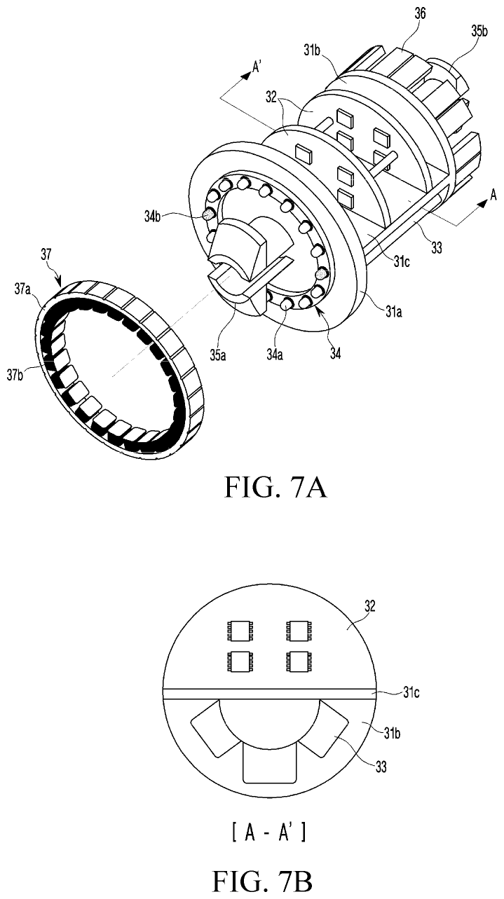

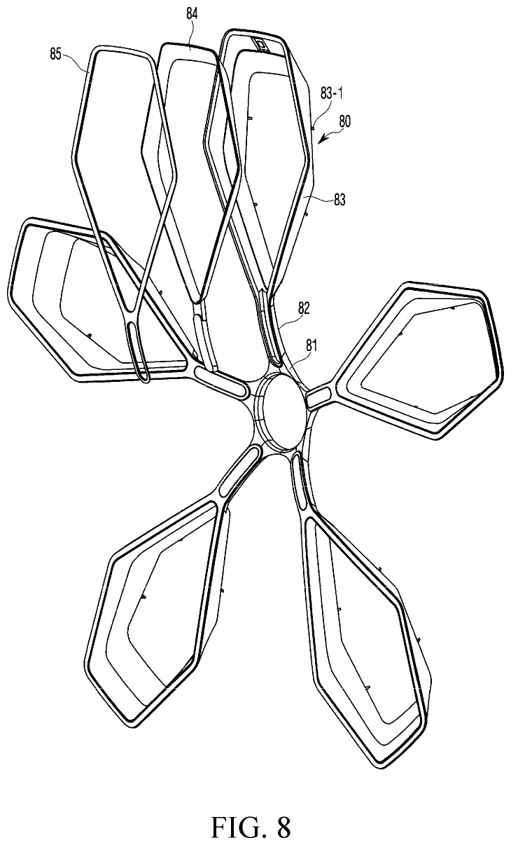

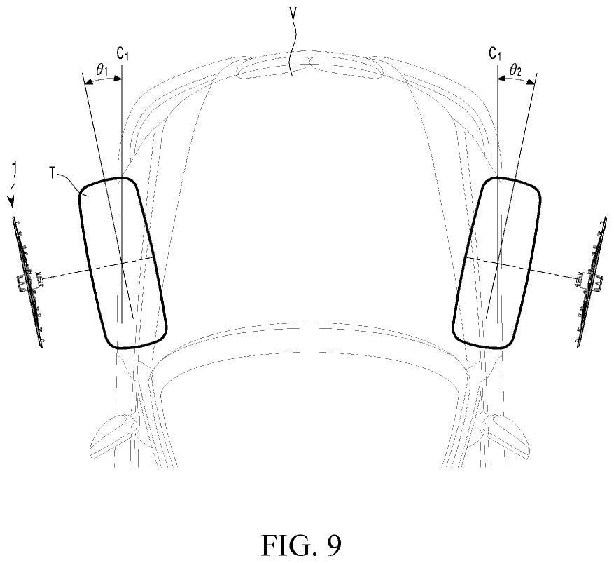

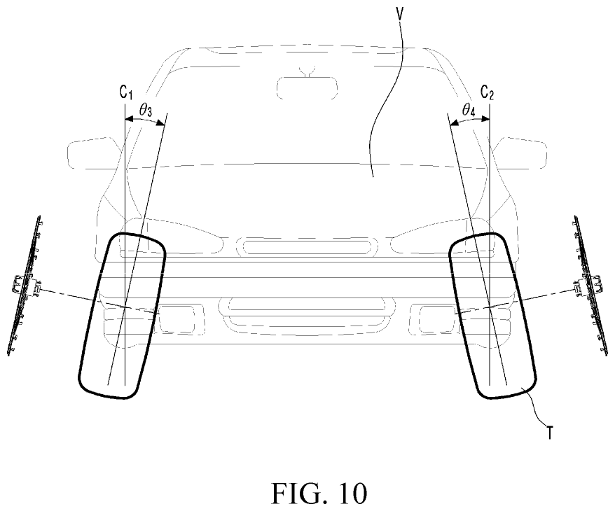

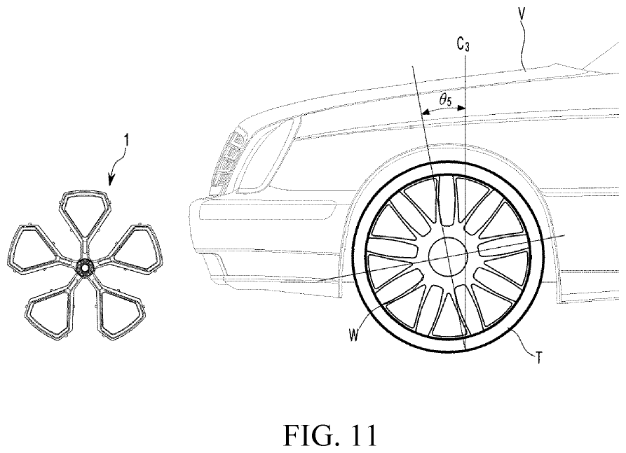

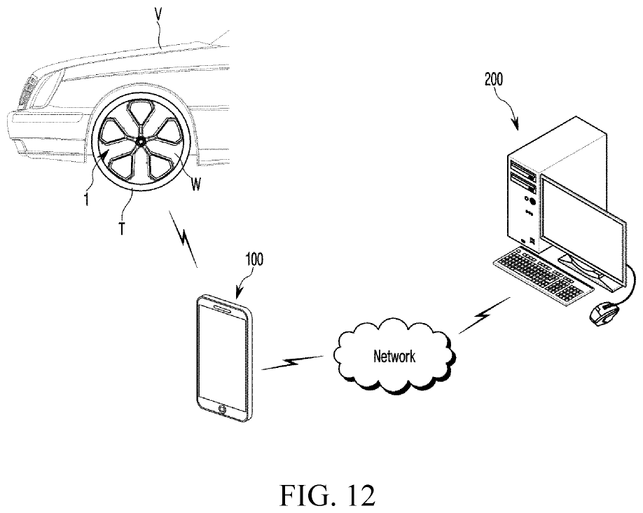

FIG. 1 is a perspective view of a smart wheel cap for a vehicle according to the present invention, FIG. 2 is an exploded perspective view of a smart wheel cap for a vehicle according to a first exemplary embodiment of the present invention, FIG. 3 is an exploded perspective view of a smart wheel cap for a vehicle according to a second exemplary embodiment of the present invention, FIG. 4 is an exploded perspective view of the smart wheel cap according to the first embodiment of the present invention, which is viewed from another aspect, FIG. 5 is an exploded perspective view of the smart wheel cap according to the second embodiment of the present invention, which is viewed from another aspect, FIG. 6 is a perspective view and a cross-sectional view of a generator unit of the smart wheel cap for a vehicle according to the first exemplary embodiment of the present invention, FIG. 7 is a perspective view and a cross-sectional view of a generator unit of the smart wheel cap for a vehicle according to the second exemplary embodiment of the present invention, FIG. 8 is a perspective view of a wing LED of a smart wheel cap for a vehicle according to the present invention, FIG. 9 is a plan view illustrating that a toe value is measured by a smart wheel cap for a vehicle according to the present invention, FIG. 10 is a front view illustrating that a camber value is measured by the smart wheel cap for a vehicle according to the present invention, FIG. 11 is a side view illustrating that a caster value is measured by the smart wheel cap for a vehicle according to the present invention, and FIG. 12 is a block diagram illustrating communication among a smart wheel cap, and a user terminal and a server according to the present invention.

A smart wheel cap 1 for a vehicle according to a first exemplary embodiment of the present invention will be described in detail with reference to FIGS. 1, 2, 4, and 6. FIG. 1 illustrates a state in which the smart wheel cap 1 for a vehicle is assembled. As illustrated in the drawings, the smart wheel cap 1 is formed by coupling a front cover 10 and a rear cover 70 to each other and a wing LED 90 is inserted into and mounted on an outer circumferential surface of the rear cover 70. On a back side of the rear cover 70, a hook 83-1 for fixing to a wheel is provided.

FIG. 2 is an exploded perspective view of a smart wheel cap 1 for a vehicle according to a first exemplary embodiment of the present invention and

FIG. 4 is an exploded perspective view of the smart wheel cap 1, which is viewed from another aspect. As illustrated in the drawings, the smart wheel cap 1 for a vehicle includes a front cover 10, a cap 20 inserted inward from the back side of the front cover 10, and a rear cover 70 fixing a generator unit 30 mounted on the back side of the cap 20 and having a mounting hook 72 for mounting the generator unit 30 on a wheel W, which is provided on a back.

The front cover 10 includes a front cover body 11 and an LED light emitting window 12 formed on a front border of the body and from which an LED light source is emitted and the LED light emitting window 12 may be made of a transparent or translucent material. Further, a front of the front cover body 11 may be opened or the front cover body 11 may be formed by a transparent window. When the front cover body 11 is formed by the transparent window, an emblem of an automobile manufacturer may be attached to the front cover body 11.

The cap 20 is constituted by a cap body 21 whose rear is opened and a bearing 22 mounted inside the front of the body 21 to prevent the generator unit 30 from rotating. A mounting hook 35a is inserted and mounted into the bearing 22 and the cap 20 rotates together as the wheel W rotates by the bearing 22, but the generator unit 30 does not rotate. The cap 20 is made of transparent or semitransparent synthetic resin series, and when the cap 20 is transparent, the color of the LED may be displayed outside as it is. When the front of the front cover 10 is opened, the emblem of the automobile manufacturer may be attached to the front of the cap 20. In addition, a display unit (not illustrated) for displaying the emblem of the manufacturer may be mounted on the inside of the front of the cap 20. The display unit is formed by an LCD panel or adopts a display similar thereto to display the emblem. When the display unit is formed by the LCD panel, it is advantages in that it is not necessary to attach a separate emblem and it is advantageous in that the emblem may be easily seen even at night. The display unit receives power from a battery 33 to turn on/off the emblem through a control unit.

The generator unit 60 is constituted by a stator unit 30 and a rotor unit 40 which is coupled with the stator unit 30 by a bearing. FIG. 6 illustrates a detailed view of the generator unit 60.

The stator unit 30 includes a pair of stationary discs 31a and 31b formed on one side and the other side, a connecting plate 31c connecting the pair of stationary discs 31a and 31b to each other, a pair of bearing hooks 35a and 35b formed on both stationary discs 31a and 31b, respectively and mounted on bearings 22 and 44, an LED module 34 mounted on the one-side stationary disc 31a, a magnet 36 radially mounted on the other-side stationary disc 31b, one or more printed circuit boards 32 mounted on an upper portion of the connecting plate 31c, and a battery 33 mounted on a lower portion of the connecting plate 31c with one or more and serving as a balance weight and storing electricity generated by a coil 43 and the magnet 36. The LED module 34 is constituted by an LED 34a mounted on a printed circuit board of a module and a side sensor 34b. The printed circuit board 32 includes a gyro sensor for measuring an acceleration of the vehicle, a mileage of the vehicle, and the angle of the wheel, a color control unit for controlling the color of the LED 34a, an MCU receiving signals sensed by the side sensor and the gyro sensor and receiving a control signal of a user terminal through a main transmitting and receiving unit to control the color control unit and the sensors, and a main transmitting and receiving unit transmitting the control signal to the MCU or receiving the control signal of the user terminal and transmitting the control signal to the MCU. The printed circuit board 32 is attached to the upper portion of the connecting plate 31c and may have a semicircular plate shape or a rectangular shape smaller than sizes of one stationary disc 31a and the other stationary disc 31b. As illustrated in the drawings, when the printed circuit board 32 has the semicircular plate shape, the printed circuit board 32 may be easily mounted and when the generator unit 60 is inserted and installed, interference may be prevented.

The rotor unit 40 includes a bearing 44 on which a bearing hook 35b of the other stationary disc 31b is mounted, a coil 43 mounted on an edge and generating electricity by rotation of the magnet 36, and a rotary disk 41 on which the bearing 44 and the coil 43 are mounted. The rotor unit 40 is fixed to the rear cover 70 by a fixation pin 45 and rotate together with the rear cover 70.

The rear cover 70 includes a body 71 whose front is opened and a hook 72 formed on the back side of the body 71 and mounted on the wheel W of the automobile. The rear cover 70 is coupled with the front cover 10 and serves to cover and protect the cap 20 and the generator unit 60. Further, a rotor is mounted on the rear cover 70 and the rear cover 70 also serves as the rotor while rotating together with the front cover 10.

As illustrated in FIG. 8, the wing LED 80 is mounted on the outer circumferential surface of the rear cover 70. The wing LED 80 is mounted on the wheel so that the side surface of the running automobile is illuminated. Therefore, surrounding vehicles or people may easily grasp the presence of the vehicle. The wing LED 80 includes a fastening body 81 having a hole formed at the center thereof, multiple connecting portions 82 radially formed in the fastening body 81, and a wing portion 83 connected to the connecting portion 82 and a hook 8301 is formed on the back side of the wing portion 83, so that the wing LED 80 may be mounted on the wheel W. An LED 84 and a holder 85 for fixing the LED 84 are coupled to the connecting portion 82 and the wing portion 83.

A smart wheel cap 1 for a vehicle according to a second exemplary embodiment of the present invention will be described in detail with reference to FIGS. 1, 3, 5, and 7. FIG. 1 illustrates a state in which the smart wheel cap 1 for a vehicle is assembled. As illustrated in the drawings, the smart wheel cap 1 is formed by coupling a front cover 10 and a rear cover 70 to each other and a wing LED 90 is inserted and mounted into on the outer circumferential surface of the rear cover 70. On the back side of the rear cover 70, the hook 83-1 for fixing to the wheel is provided.

FIG. 3 is an exploded perspective view of a smart wheel cap 1 for a vehicle according to the present invention and FIG. 5 is an exploded perspective view of the smart wheel cap according to the present invention, which is viewed from another aspect. As illustrated in the drawings, the smart wheel cap 1 for a vehicle includes a front cover 10, a cap 20 inserted inward from the back side of the front cover 10, and a rear cover 70 fixing a generator unit 30 mounted on the back side of the cap 20 and having a mounting hook 72 for mounting the generator unit 30 on a wheel W, which is provided on a back.

The front cover 10 includes a front cover body 11 and an LED light emitting window 12 formed on a front border of the body and from which an LED light source is emitted. A front of the front cover body 11 may be opened or the front cover body 11 may be formed by a transparent window. Further, when the front cover body 11 is formed by the transparent window, an emblem of an automobile manufacturer may be attached to the front cover body 11.

The cap 20 is constituted by a cap body 21 and an auxiliary magnet 23 attached to an inner circumferential surface of the body and a bearing 22 is mounted on a front inside of the body 21. The auxiliary magnet 23 is radially attached to the inner circumferential surface to generate electricity together with an auxiliary coil 37 of the generator unit 30. A mounting hook 35a is inserted and mounted into the bearing 23 and the cap 20 rotates together as the wheel W rotates by the bearing 22, but the generator unit 30 does not rotate. The cap 20 is made of transparent or semitransparent synthetic resin series, and when the cap 20 is transparent, the color of the LED may be displayed outside as it is. When the front of the front cover 10 is opened, the emblem of the automobile manufacturer or a wheel cap manufacturer may be attached to a front surface of the cap 20. In addition, a display unit (not illustrated) for displaying the emblem of the manufacturer may be mounted on the inside of the front of the cap 20. The display unit is formed by an LCD panel or adopts a display similar thereto to display the emblem. When the display unit is formed by the LCD panel, it is advantages in that it is not necessary to attach a separate emblem and it is advantageous in that the emblem may be easily seen even at night. The display unit receives power from a battery 33 or a secondary battery 51 to turn on/off the emblem through a control unit.

The generator unit 60 includes a stator unit 30, a rotor unit 40 that is coupled with the stator unit 30 by a bearing, and a secondary battery unit 50 that is fixed to the back side of the rotor unit 40 do. FIG. 7 illustrates a detailed view of the generator unit 60.

The stator unit 30 includes a pair of stationary discs 31a and 31b formed on one side and the other side, a connecting plate 31c connecting the pair of stationary discs 31a and 31b to each other, a pair of bearing hooks 35a and 35b formed on both stationary discs 31a and 31b, respectively and mounted on bearings 22 and 44, an auxiliary coil 37 mounted on the one-side stationary disc 31a in order to generate electricity together with the auxiliary magnet 23, an LED module 34 mounted on the one-side stationary disc 31a and positioned inside the auxiliary coil 37, a magnet 36 radially mounted on the other-side stationary disc 31b, one or more printed circuit boards 32 mounted on an upper portion of the connecting plate 31c, and a battery 33 mounted on a lower portion of the connecting plate 31c and serving as a weight balance and storing the electricity generated by the auxiliary coil 37 and the auxiliary magnet 22. The printed circuit board 32 includes a transmitting and receiving unit that receives a sensor signal of a side sensor 34b for sensing an object on a side surface etc., and transmitting the received sensor signal to an MCU of a secondary printed circuit board 52 or receiving a control signal of the MCU and a color control unit capable of a color of an LED by receiving the control signal of the MCU. The control signal of the LED color is transmitted through the user terminal. Further, the LED module 34 is constituted by an LED 34a mounted on a printed circuit board and a side sensor 34b. The printed circuit board 32 may have a semi-disc shape as illustrated in the drawings and the resulting advantage is the same as those of the first exemplary embodiment, and as a result, a description thereof will be omitted.

The rotor unit 40 includes a bearing 44 on which a bearing hook 35b of the other stationary disc 31b is mounted, a coil 43 mounted on an edge and generating electricity of the magnet 36, and a rotary disk 41 on which the bearing 44 and the coil 43 are mounted. The rotor unit 40 is fixed to the secondary battery unit 50 and the rear cover 70 by a fixation pin 45 and rotate together with the rear cover 70.

The secondary battery unit 50 includes a secondary printed circuit board 52 and a secondary battery 51 in which the second printed circuit board 52 is attached to one side, one side to which the secondary printed circuit board 52 is attached is mounted on the back side of the other-side stationary disc 31b, and the other side fixed to the inside of the rear cover 70. The secondary printed circuit board 52 includes a gyro sensor for measuring the acceleration, the traveling distance, and the angle of the wheel of the vehicle, an MCU receiving signals sensed by the side sensor and the gyro sensor and receiving the control signal of the user terminal through a main transmitting and receiving unit to control the color control unit and the sensors, and a main transmitting and receiving unit transmitting the control signal to the user terminal or receiving the control signal of the user terminal and transmitting the received control signal to the MCU. Functions and configurations of the printed circuit board 32 and the secondary printed circuit board 52 may be mounted while being replaced with each other.

The rear cover 70 includes a body 71 whose front is opened and a hook 72 formed on the back side of the body 71 and mounted on the wheel W of the automobile. The rear cover 70 is coupled with the front cover 10 and serves to cover and protect the cap 20 and the generator unit 60. Further, a rotor is mounted on the rear cover 70 and the rear cover 70 also serves as the rotor while rotating together with the front cover 10.

As illustrated in FIG. 8, the wing LED 80 is mounted on the outer circumferential surface of the rear cover 70. The wing LED 80 is mounted on the wheel so that the side surface of the running automobile is illuminated. Therefore, surrounding vehicles or people may easily grasp the presence of the vehicle. The wing LED 80 includes a fastening body 81 having a hole formed at the center thereof, multiple connecting portions 82 radially formed in the fastening body 81, and a wing portion 83 connected to the connecting portion 82 and a hook 8301 is formed on the back side of the wing portion 83, so that the wing LED 80 may be mounted on the wheel W. An LED 84 and a holder 85 for fixing the LED 84 are coupled to the connecting portion 82 and the wing portion 83.

FIGS. 9 to 11 illustrate a state of a tire, which may be measured by the smart wheel cap 1 for a vehicle according to the present invention. Values of a toe (FIG. 9), a camber (FIG. 10), and a caster (FIG. 11) may be measured by a gyro sensor of the smart wheel cap 1 for a vehicle according to the present invention. As the measured values are transmitted to the user terminal 100 and displayed on the user terminal 100, the user may take an appropriate action.

FIG. 12 is a diagram illustrating a relationship of a smart wheel cap 1 for a vehicle, a user terminal 100, and a server 200. The smart wheel cap 1 for a vehicle according to the present invention interlocks with an application that may be controlled through the user terminal 100 and the application interlocks with the server 200 via a network. The application through the user terminal 100 includes a control unit that may display a total traveling distance, the acceleration of the vehicle, the angle of the wheel, and the color the LED, inform whether a tire is replaced when a set value for replacing the tire is reached from the total traveling distance, and control the color of the LED. Specifically, the smart wheel cap 1 for a vehicle measures values of a toe, a camber and a caster of the vehicle using a gyro acceleration sensor. Signals for the values of the toe, camber and caster measured by the gyro acceleration sensor are transmitted to the user terminal through the MCU. Communication of the terminal 100 and the smart wheel cap 1 may adopt various communication methods and as a general example, the terminal 100 and the smart wheel cap 1 may communicate with each other by using Bluetooth and as the Bluetooth, Bluetooth 4.0 may be used. The terminal 100 analyzes the signal transmitted through the sensor of the wheel cap 1 and calculates and displays the angles of the toes θ₁ and θ₂, cambers θ₃ and θ₄, and the caster θ₅ on the terminal. The terminal 100 determines whether one-sided wear occurs on the tire based on the displayed toe, camber, and caster value and when the respective values are not symmetric to each other, the terminal 100 determines whether the one-sided wear occurs to provide information on an automobile repair shop to the user terminal 100. That is, since the user terminal 100 has a GPS system, the user terminal 100 grasps a current location of a user, asks the user whether to desire information about the repair shop around the user, and requests if the user desires, the user terminal 100 requests the information to the server 200 through the network, the server 200 may send information on the automobile repair shop around the current location of the user by grasping the current location of the user. Further, even when wheel alignment is not performed according to a measurement value of the gyro sensor, same process may be accompanied. The user terminal 100 and the wheel cap 1 directly transmit and receive the signal for the color and the MCU of the printed circuit board or the MCU of the secondary printed circuit board of the wheel cap 1 receiving the signal of the user terminal 100 sends the signal to the color control unit and the color control unit changes the LED color of the wheel cap. Further, the color of the LED may be adjusted according to a circumstance by using open source data through the server 200. That is, the user may receive information on a surrounding weather at a place where the automobile is currently positioned through the open source data, and automatically change the color of the LED according to surrounding weather conditions through the color control unit. Further, when the signal sensed through the side sensor is transmitted to the user terminal 100 through the printed circuit board or the secondary printed circuit board, the application of the user terminal 100 gives a warning message to the user, accordingly, the user may recognize that there is an object on the side and perform safe driving.

In addition, when the application executed in the user terminal inputs a replacement cycle time of the tire, the traveling distance is grasped through the gyro sensor, and the traveling distance at the input replacement cycle time is compared with the grasped traveling distance and when the grasped traveling distance corresponds to the traveling distance at the corresponding replacement cycle time, it is notified that the replacement time is reached to the user terminal. Therefore, it is possible to use the tire efficiently even by exchanging front and rear tires.

Further, the application of the user terminal may calculate a total traveling distance of the tire and display the calculated total traveling distance on the user terminal.

While it has been described that various modifications of the present invention can be made with reference to exemplary embodiments of the present invention, it is to be understood that the present invention is not limited to the disclosed exemplary embodiments, but, on the contrary, it is to be understood that the techniques that can be modified and used by those skilled in the art in the claims and the detailed description of the present invention are included in the technical scope of the present invention.

What is claimed is:

1. A smart wheel cap for a vehicle, comprising;
a front cover emitting light to the outside and including a cover body and an LED light emitting window mounted on a front border of the cover body;
a cap including a cap-shaped cap body which is mounted on a back side of the front cover, and has the back side opened, and is transparent or translucent and a primary bearing mounted on a front inside of the cap body;
a generator unit including a stator unit including a pair of stationary discs mounted on the back side of the cap, formed on one side and the other side, a connecting p late connecting the pair of stationary discs to each other, a pair of bearing hooks formed on both stationary discs, respectively and mounted on a bearing, a magnet radially mounted on the other-side stationary disc, and a battery mounted on a lower portion of the connecting plate with one or more and serving as a balance weight and storing electricity generated by the magnet and a coil, and a rotor unit including a bearing on which the bearing hook of the other-side stationary disc with the magnet is mounted, a coil mounted on an edge and generating the electricity together with the magnet, and a rotary disc on which the bearing and the coil are mounted and rotating together with the front cover or cap; and
a rear cover coupled with the front cover and fixing locations of the cap and the generator unit, and having a mounting hook mounted on a wheel, which is provided on a back.

2. The smart wheel cap for a vehicle of claim 1, wherein in the generator unit, an LED module is mounted on the one-side stationary disc and one or more printed circuit boards are mounted on an upper portion of the connecting plate.

3. The smart wheel cap for a vehicle of claim 2, wherein the cap further includes an auxiliary magnet radially mounted inside the side surface of the cap body, and
the generator unit includes
an auxiliary coil mounted on the one-side stationary disc in order to generate the electricity together with the auxiliary magnet, and
a second battery unit including a secondary printed circuit board and an auxiliary battery in which the secondary printed circuit board is attached to one side, one side to which the secondary printed circuit board is attached is mounted on the back side of the rotary disc, and the other side fixed to the inside of the rear cover.

4. The smart wheel cap for a vehicle of claim 3, wherein the printed circuit board includes a color control unit controlling a color of an LED, a side sensor for sensing an object on the side of a wheel, and a transmitting and receiving unit transmitting a signal sensed by the side sensor to an MCU and receiving a control signal of the MCU.

5. The smart wheel cap for a vehicle of claim 4, wherein the secondary printed circuit board includes a gyro sensor for measuring the acceleration, the traveling distance, and the angle of the wheel of the vehicle, an MCU receiving signals sensed by the side sensor and the gyro sensor and receiving the control signal of the user terminal through a main transmitting and receiving unit to control the color control unit and the sensors, and a main transmitting and receiving unit transmitting the control signal to the user terminal or receiving the control signal of the user terminal and transmitting the received control signal to the MCU.

6. The smart wheel cap for a vehicle of claim 2, wherein the printed circuit board includes a color control unit controlling the color of the LED, the side sensor for sensing the object on the side of the wheel, a gyro sensor for measuring an acceleration, a traveling distance, and an angle of the wheel of the vehicle, an MCU receiving signals sensed by the side sensor and the gyro sensor and receiving a control signal of a user terminal through a main transmitting and receiving unit and controlling the color control unit and the sensors, and a main transmitting and receiving unit transmitting the control signal of the MCU or receiving the control signal of the user terminal and transmitting the control signal to the MCU.

7. The smart wheel cap for a vehicle of claim 5, wherein the user terminal includes a control unit that may display a total traveling distance, the acceleration of the vehicle, the angle of the wheel, and the color the LED, inform whether a tire is replaced when a set value for replacing the tire is reached from the total traveling distance, and control the color of the LED.

8. The smart wheel cap for a vehicle of claim 6, wherein the user terminal includes a control unit that may display a total traveling distance, the acceleration of the vehicle, the angle of the wheel, and the color the LED, inform whether a tire is replaced when a set value for replacing the tire is reached from the total traveling distance, and control the color of the LED.
